(19) United States
(12) Patent Application Publication
(10) Pub. No.: US 2006/0010742 A1
(43) Pub. Date: Jan. 19, 2006

(54) Label having grip tab and method for the manufacture thereof

(76) Inventor: Maximilian Steininger, Allershausen (DE)

Correspondence Address: WILLIAM COLLARD;COLLARD & ROE, P.C., 1077 NORTHERN BOULEVARD, ROSLYN, NY, 11576, US

(21) Appl. No.: 11/137,037

(22) Filed: May 25, 2005

(30) Foreign Application Priority Data
May 26, 2004 (DE) 10 2004 025 711.6

(51) Int. Cl. G09F 3/10

(52) U.S. Cl. 40/638

(57) ABSTRACT

A label (201) has a grip tab in the region A and an embossing or other deformation (205), due to which the grip tab stands up in the edge region between deformation and tab edge. Through the deformation (205/305), a material tension is built up which causes the film layer (302) to stand up at the edge of the region A of the grip tab. A material tension of this type preferably builds up when using plastic films as the film layer (302). Either no adhesive is applied or the effect of an adhesive layer applied over the entire area is partially or completely canceled out by suitable agents (e.g., “adhesive killers”) in the region A of the grip tab. In any case, the adhesive effect on the bottom in region A is reduced in relation to the adhesive effect in the directly adjoining region.

### CROSS REFERENCE TO RELATED APPLICATIONS

Applicant claims priority under 35 U.S.C. §119 of German Patent Application No. 10 2004 025 711.6 filed May 26, 2004.

### BACKGROUND OF THE INVENTION

1. Field of the Invention

The present invention relates to a label having a non-adhesive or only weakly adhesive grip tab and a method for its manufacture. Labels of this type are used in many ways, above all in the field of technical and pharmaceutical identification. In this case, the grip tab is used for easier removal of the label or parts of the label, for example, in order to stick the label or parts thereof on again at another location.

2. The Prior Art

For the identification of pharmaceutical products it is typical, for example, to equip removable label parts with a non-adhesive or only weakly adhesive grip tab of this type, in order to remove the label parts as vouchers for patient files and stick them in the files. A label having voucher sections of this type is described, for example, in DE 10239510 A1. The voucher sections described therein are implemented on the upper edge having corresponding small grip tabs (FIG. 2). With the aid of voucher labels of this type, unbroken evidence of the administration of a pharmaceutical is made possible.

A further example of labels having non-adhesive or weakly adhesive grip tabs is the area of protective labels in the technical field. These labels are used, for example, for temporarily covering holes in machine blocks which are protected by labels from contamination during mounting.

Labels having non-adhesive or weakly adhesive grip tabs may be manufactured in two different ways. In a first variation, a label is stamped out of a film web provided only partially or not at all with adhesive on the bottom and possibly provided with adhesive (for example, through printing methods). In the second variation, a film web completely coated on the bottom with adhesive is covered on the bottom or treated with agents that partially or completely cancel out the effect of the adhesive in the region provided for the grip tab. This may be performed through covering and/or treatment over the entire area or through local cancellation and/or weakening of the adhesive effect of the adhesive on the bottom, in the form of punctual or linear rasters, for example.

The problem typically arises in labels or label parts having non-adhesive or weakly adhesive grip tabs of this type that the tabs may only be gripped with difficulty. This occurs especially in the operation field, for example, if medical personnel having protective gloves remove the label or label parts and wish to stick them in patient files. In the second exemplary application of protective covering of a hole in a machine block, a similar problem arises, since here gloves must often be worn as a work protection.

For this purpose, covering part or all of the area of the bottom of the grip tab with the aid of a film piece, as described in EP 546047 B1, for example, provides an approach. The disadvantage in this case is a multilayered and more costly construction of the label, which must be manufactured through complex bottom dispensing or other complicated stamping and lamination techniques. In addition, after the label is dispensed onto the object to be labeled, the grip tab lies flat on the surface, so that the gripping is still made only slightly easier.

### SUMMARY OF THE INVENTION

The present invention is therefore based on the object of providing a label whose grip tab is easily grippable. Furthermore, the present invention is to achieve the object of providing a very cost-effective manufacturing method for easily grippable labels of this type.

The object is achieved in that a standing-up effect is achieved in the region of the grip tab through a suitable deformation.

### BRIEF DESCRIPTION OF THE DRAWINGS

Other objects and features of the present invention will become apparent from the following detailed description considered in connection with the accompanying drawings. The advantages of the present invention are illustrated in the drawings. It should be understood, however, that the drawings are designed for the purpose of illustration only and not as a definition of the limits of the invention.

In the drawings:

FIG. 1 represents a side view of the film construction of a label having a grip tab according to the related art.

FIG. 2 shows a first especially preferred embodiment of the present invention in a top view.

FIG. 3 shows the same embodiment in the side view along the section line I-I′ from FIG. 2.

FIG. 4 shows a further especially preferred embodiment of the present invention in a top view, analogously to FIG. 2.

### DETAILED DESCRIPTION OF PREFERRED EMBODIMENTS

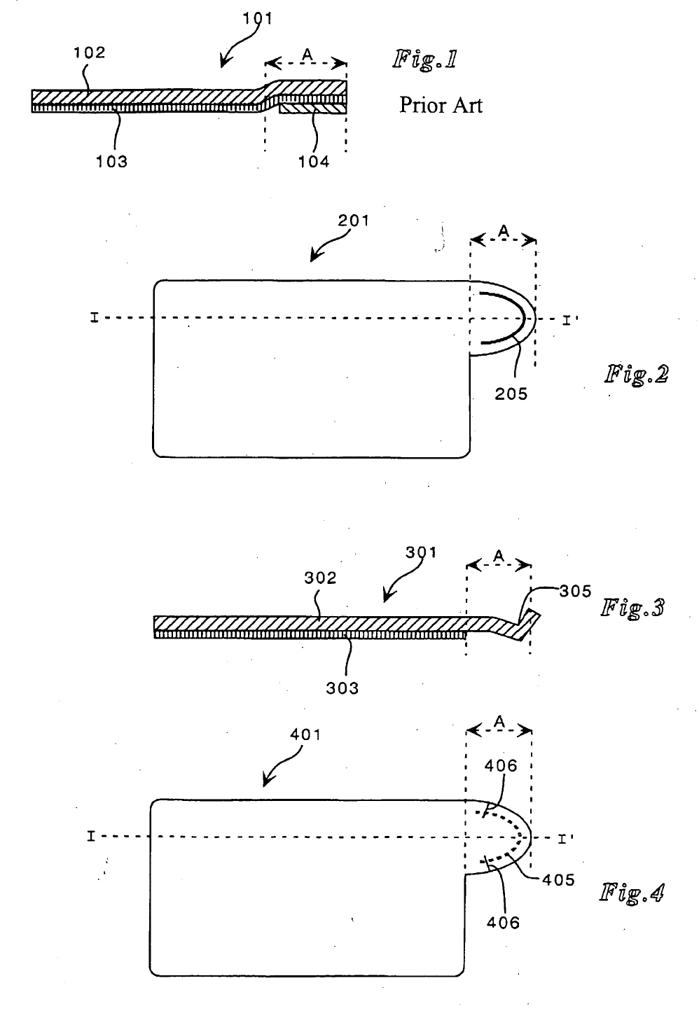

A label 101 having a grip tab (region A) according to the related art is shown in FIG. 1. It comprises at least one film layer 102 and an adhesive layer 103 lying underneath. An agent for weakening or canceling out the adhesive force and/or a cover 104 is applied on the bottom in the region A of the grip tab. In the most common embodiment, the adhesive force is weakened, and/or canceled out, using an agent which is printed on, for example, using an ink or a lacquer. In order to nonetheless make it slightly easier to grip the grip tab in the region A, the layer 104 must be a cover in the form of the thickest possible film layer.

FIG. 2 shows a top view of a label 201 according to the present invention having a grip tab in the region A. It has an embossing or other deformation 205, through which the grip tab stands up in the edge region between deformation and tab edge.

This is recognizable in FIG. 3, in which the label 301 according to the present invention (numbered analogously) is shown. It comprises at least one film layer 302, which is provided on the bottom over at least a part of the area with adhesive 303. Either no adhesive is applied or the effect of an adhesive layer applied over the entire area is partially or completely canceled out by suitable agents (“adhesive killers”) in the region A of the grip tab. In any case, the adhesive effect on the bottom in region A is reduced in relation to the adhesive effect in the directly adjoining region. The deformation 305 is recognizable in region A.

Considering FIGS. 2 and 3 together illustrates how a material tension is built up by the deformation 205/305, which causes the film layer 302 to stand up at the edge of the region A of the grip tab.

A material tension of this type is built up, for example, when using plastic films as the film layer 302; however, using a suitable thick paper layer as the film layer 302 is also conceivable.

In addition to the material selection, the shape of the deformation 205/305 is decisive for the particular standing-up effect. A deformation which runs approximately along the edge of the grip tab has been shown to be especially advantageous. In an especially preferred embodiment, the shape of the deformation corresponds to the course of the grip tab, slightly different courses not having a disadvantageous effect especially in the two end regions of the deformation. In order to build up a suitable material tension, it is also recommended that a curved shape preferably be selected for the deformation. Furthermore, it is possible to give this curved shape a wavy course.

In FIG. 4, a further preferred embodiment of a label 401 according to the present invention is shown. The label 401 is drawn with a shape analogous to FIG. 2. Two essential differences result only in the region A of the grip tab:

Firstly, the deformation 405 is not implemented continuously in the form of a line, but rather in the form of a line of embossed dots. Furthermore, it is also possible to use an interrupted embossed line, since in all three illustrated cases (continuous or interrupted embossed line or line of embossed dots), building up a sufficiently strong material tension and the desired standing-up effect may be achieved.

Secondly, two stamped or cut lines 406 are additionally shown in FIG. 4. They cause an even stronger standing-up effect, since the force of the material tension which is built up in the two end regions of the deformation does not act in the adjoining region of the label.

The desired standing-up effect of the grip tab may also be achieved again after the label is wound up on a roll and the material webs lying above accordingly press it into the roll: experiments with a load of labels according to the present invention having a mass of 10 kg simulated the load which would arise through winding the labels on a roll. The standing-up effect was temporarily canceled out by this load, but after the labels were dispensed from the carrier material onto another substrate, the surprising effect resulted that the edge regions of the grip tabs stood up by themselves again without problems in all labels.

In the embodiments of the present invention described up to this point, the standing-up effect of the grip tab was based on a material tension in the region of the deformation toward the edge of the tab. However, it is also possible to implement the deformation so strongly that the grip tab stands up over a larger area. For example, it is possible with the aid of an embossing mold and a counter mold to achieve a deeper deformation on the bottom of the grip tab, because of which a bulge downward results, which results in raising of the entire grip tab. Strong deformations of this type are typically achieved either through stronger application of force during the deformation in comparison to the embodiments described above or through (possibly additional) application of higher temperatures (thermal deformation). For example, a permanent deformation is ensured in the deep-drawing method.

This embodiment of the present invention is especially expedient if the selected label material is a very stiff film. A lever effect arises at the transition from the grip tab to the adhesive region of the label on the bottom because of the partial deformation of the tab.

In this embodiment of the present invention, the deformation does not necessarily have to be near the edge of the grip tab and may additionally assume other shape variations: for example, simple punctual deformations in the central region of the tab, multiple punctual stamps at regular or irregular intervals, thicker embossed dots having a circumference which comprises the greater part of the grip tab, as well as simple geometrical figures such as circles, squares, curves, and triangles are possible. Multiple embossed elements, which may also be positioned in a raster, are also possible, depending on the shape of the grip tab.

The preferred type of the deformation according to the present invention is embossing, which represents the most cost-effective variation in most cases because of the simple manufacturing principle. However, it is also possible to use other deformations of a mechanical (such as rolling, squeezing, compressing, or deep drawing) or even more generally physical (effect of electromagnetic waves or radiation) and/or chemical type.

Although only a few embodiments of the present invention have been shown and described, it is to be understood that many changes and modifications may be made thereunto without departing from the spirit and scope of the invention as defined in the appended claims.

What is claimed is:

1. A label (201, 301, 401) having at least one grip tab, which is non-adhesive or more weakly adhesive than the region directly adjoining the grip tab, comprising at least one deformation (205, 305, 405) located in the region of the tab.

2. The label according to claim 1, wherein said at least one deformation comprises multiple deformations (205, 305, 405).

3. The label according to claim 2, wherein the multiple deformations (205, 305, 405) are positioned in a raster.

4. The label according to claim 1, wherein said at least one deformation (205, 305, 405) comprises a perforation.

5. The label according to claim 2, wherein at least one deformation (205, 305, 405) or the entirety of the deformations (205, 305, 405) has the external shape of a geometric figure.

6. The label according to claim 2, wherein at least one deformation (205, 305, 405) or the entirety of the deformations (205, 305, 405) is linear.

7. The label according to claim 6, wherein the deformation (205, 305) is a continuous embossed line.

8. The label according to claim 6, wherein the deformation (405) is an interrupted embossed line.

9. The label according to claim 6, wherein the deformation (405) is a line of embossed dots.

10. The label according to claim 2, wherein at least one deformation (205, 305, 40.5) or the entirety of the deformations (205, 305, 405) runs along the edge of the grip tab.

11. The label according to claim 2, wherein the course of the at least one deformation (205, 305, 405) or the entirety of the deformations (205, 305, 405) corresponds to at least the greater part of the course of the edge of the grip tab.

12. The label according to claim 1, wherein the at least one deformation (205, 305, 405) runs at a concrete distance from the edge of the grip tab.

13. The label according to claim 2, wherein at least one deformation (205, 305, 405) or the entirety of the deformations (205, 305, 405) has a course deviating from a straight line.

14. The label according to claim 13, wherein at least one deformation (205, 305, 405) or the entirety of the deformations (205, 305, 405) is curved.

15. The label according to claim 13, wherein at least one deformation (205, 305, 405) or the entirety of the deformations (205, 305, 405) is wavy.

16. The label according to claim 1, further comprising at least one plastic film layer (302).

17. The label according to claim 1, wherein the label is a single-layer label.

18. The label according to claim 1, further comprising at least one removable voucher section.

19. The label according to claim 18, wherein the at least one grip tab is in the region of the at least one voucher section.

20. The label according to claim 1, wherein the label has no adhesive layer (303) in the region of the grip tab.

21. The label according to claim 1, wherein the effect of an adhesive layer (303) is reduced or canceled out in the region of the grip tab through suitable agents.

22. The label according to claim 21, wherein an adhesive layer (303) is covered on the bottom in the region of the grip tab by a further film layer.

23. The label according to claim 1, further comprising at least one stamp or one cut (406), which runs from the tab edge up to at least one deformation (405), in the region of the at least one grip tab.

24. A method for manufacturing a label (201, 301, 401) having at least one grip tab, in which at least one deformation (205, 305, 405) is performed in the region of the grip tab.

25. The method according to claim 24, wherein the deformation is achieved through a chemical effect.

26. The method according to claim 24, wherein the deformation is achieved through a physical effect.

27. The method according to claim 26, wherein the physical deformation is the application of electromagnetic waves or radiation.

28. The method according to claim 26, wherein the physical deformation is a thermal deformation.

29. The method according to claim 26, wherein the physical deformation is a mechanical deformation.

30. The method according to claim 29, wherein the mechanical deformation is embossing, squeezing, compressing, rolling, or deep drawing.

31. The method according to claim 24, wherein the deformation is at least one deformation on the side of the label which is at least partially coated with adhesive.

32. The method according to claim 24, wherein the deformation is performed from both sides of the label.

33. The method according to claim 32, wherein the deformation on both sides is performed with the aid of an embossing mold and a counter mold implemented as a negative.
